(19) United States
(12) Patent Application Publication
(10) Pub. No.: US 2026/0116784 A1
(43) Pub. Date: Apr. 30, 2026

(54) COMPOSITIONS AND METHOD FOR WASTEWATER TREATMENT

(71) Applicant: INLAND ENVIRONMENTAL RESOURCES, INC., Spokane, WA (US)

(72) Inventors: Douglas George Kellely, Granger, WA (US); Peter Nelson Svebakken, Waukon, IA (US); Andrew Rossetti, Hartford, WI (US)

(73) Assignee: INLAND ENVIRONMENTAL RESOURCES, INC., Spokane, WA (US)

(21) Appl. No.: 19/356,702

(22) Filed: Oct. 13, 2025

Related U.S. Application Data
(60) Provisional application No. 63/714,437, filed on Oct. 31, 2024.

(51) Int. Cl. C02F 1/00; C02F 1/68; C02F 101/10

(52) U.S. Cl. CPC C02F 1/008; C02F 1/68; C02F 2101/101; C02F 2209/06; C02F 2209/07; C02F 2209/14; C02F 2209/22; C02F 2209/26; C02F 2209/40; C02F 2303/02

(57) ABSTRACT

A method of treating wastewater in sewer lines prevents or inhibits the formation and release of hydrogen sulfide from the wastewater. The method includes the step of injecting a water treatment chemical that reacts with sulfur in the sewer line only when the instant flow rate of wastewater is below a threshold flow rate at which hydrogen sulfide is most likely to form and release.

### RELATED APPLICATIONS

This application claims priority from U.S. Provisional Application No. 63/714,437, filed Oct. 31, 2024, the contents of the above-referenced application is incorporated by reference as if fully set forth herein.

### FIELD OF THE INVENTION

This invention is directed to methods and compositions for removing hydrogen sulfide from wastewater and/or preventing its formation.

### BACKGROUND OF THE INVENTION

Wastewater diurnal flow is the daily flow pattern of wastewater in sewer systems and can vary from day to day. For example, on most weekdays, a typical residential community may have two flow spikes, one in the morning and one in the evening. On Fridays, the morning flow spike might resemble other weekday mornings, and the evening flow spike might be broader. On weekends and holidays, the morning flow spike might occur later and more broadly, and the evening flow spike might also be broader. Commercial flows typically start in the morning and peak in the late morning or early afternoon. Industrial flows prevail throughout the workday and typically peak in the afternoon, and occasionally in the evening.

Numerous chemical products are injected into sewer lines to minimize the production and release of hydrogen sulfide gas from the sewage. Hydrogen sulfide gas has a strong unpleasant odor and chemically reacts with oxygen and water to form sulfuric acid which, in turn, is highly corrosive. Chemical compounds that are used to treat the sewage and prevent the release of hydrogen sulfide include, for example, magnesium hydroxide, magnesium oxide, calcium hydroxide, calcium oxide, sodium hydroxide, sodium carbonate, sodium bicarbonate, potassium carbonate, potassium bicarbonate, hydrogen peroxide, ferric chloride, ferrous chloride, ferrous sulfate, other ferrous and ferric salts, salts of nitrate (sodium, calcium, etc.), chlorine, sodium hypochlorite, other oxidizers, and combinations thereof. Typically, these chemicals are injected into the sewage stream by direct injection of the chemical into the sewer line. These chemicals are typically injected in amounts ranging from about 50 ppm to about 500 ppm based on the estimated wastewater flow over a predetermined period of time.

Conventionally, the chemical treatment of wastewater in the collection system has been carried out in one of two ways. One way is to steadily feed the chemical into the sewer line continuously, with periodic adjustments of chemical feed rate based on fluctuations in numerous wastewater parameters (wastewater flow rate, ambient temperature, pH, hydrogen sulfide readings, etc.), thus feeding the chemical throughout the entire day. Another way is to feed the chemical only when a wastewater lift station pump is activated, again feeding the chemical at least intermittently throughout the entire day. Yet these techniques are imperfect and often fail to eliminate or substantially reduce the emission of hydrogen sulfide gas or result in gross overfeed of the treatment chemical into the wastewater sewer line. There is a need or desire to optimize the feed rates of wastewater treatment chemicals to optimize reduction in hydrogen sulfide generation and reduction in chemical usage.

### SUMMARY OF THE INVENTION

The inventors have discovered, surprisingly, that optimal reduction of hydrogen sulfide generation in the wastewater collection system can be achieved by feeding the sewage treatment chemical only when the flow rates of wastewater in the sewer line drop below certain predetermined thresholds. In other words, the sewage treatment chemicals are injected only during the off-peak periods of wastewater flow to achieve optimal reduction of hydrogen sulfide generation at all times, even during times of peak wastewater flow. Without intending to be bound by theory, it is believed that hydrogen sulfide forms in a sewer line during times of a relatively slow wastewater flow rate and is less likely to be generated when the wastewater flow rate through the sewer pipeline is high. When the wastewater flow rate falls below a certain threshold, lengthening the detention time of the wastewater in a certain section of the sewer line, the bacteria in the line consume all of the dissolved oxygen (DO) in the water and begin to convert sulfate (SO₄²⁻) into hydrogen sulfide. This effect is more noticeable during the summer months when warm weather increases the rate of microbiological activity and pedestrians passing over the sewer vents are exposed to noticeably foul odors. The effect is also more noticeable in the wee hours of the morning before most people rise and shower because, during that period, wastewater flow can slow to a trickle.

Failure to appreciate these trends has, in the past, resulted in wastewater treatment chemicals being injected into sewer lines during time of high wastewater flow, when the chemicals are least needed. Conversely, there has been insufficient treatment of the wastewater in the pipelines during times of low wastewater flow, when the relatively more stagnant wastewater in the pipelines enabled the release of noxious hydrogen sulfide gas which, in turn, reacted with moisture and oxygen to form corrosive sulfuric acid. The present invention reverses the conventional methods of wastewater treatment by 1) timing the injection of chemicals to occur only when the flow of wastewater is relatively slow, and 2) dosing the chemical at a feed rate that is inversely proportional to the flow rate of wastewater passing through the treated sewer line. The inventive method not only optimizes the control of odor and corrosion, but dramatically reduces the amount of wastewater treatment chemical that is used over time.

The present invention is directed to a method of regulating the feed of wastewater treatment chemical into a section of a sewer pipeline having a first end and a second end.

On one embodiment of the method, one step is to obtain a flow rate profile for the section of sewer pipeline to be treated. The flow rate profile uses empirical data to record and approximate the wastewater flow rate over time and can be used to predict the instant wastewater flow rate at various times of the day, on different days of the week, and in different months of the year.

In one embodiment of the method, another step is to obtain a hydrogen sulfide profile for the section of sewer pipeline that is being treated. The hydrogen sulfide profile uses empirical data to record and approximate the onset and offset of hydrogen sulfide generation over time at a selected point along the section of sewer pipeline, for example, by continuously monitoring hydrogen sulfide generation at the second end of the section of sewer pipeline. The hydrogen sulfide profile can be used to predict the instant wastewater flow rate and time at which hydrogen sulfide is generated (during periods of decreasing wastewater flow) and the instant wastewater flow rate and time at which hydrogen sulfide is no longer generated (during periods of increasing wastewater flow). The hydrogen sulfide profile can be used interactively with the flow rate profile to predict when hydrogen sulfide will be generated, and when it will stop being generated, at various times of the day, on different days of the week, and in different months of the year.

In one embodiment of the method, another step is to predict the detention time of wastewater in the section of sewer pipeline under low flow rate conditions, i.e., during the predicted periods of hydrogen sulfide generation. This can be accomplished by first calculating the volume of the section of sewer pipeline by multiplying its cross-sectional area by its length, and then dividing the volume by a representative instant wastewater flow rate (or average) during the period of hydrogen sulfide generation to yield a predicted detention time. The representative instant flow rate can be determined or estimated using the wastewater flow rate profile.

In one embodiment of the method, another step is to initiate the feed of wastewater treatment chemical at the first end of the section of sewer pipeline at a time equal to the onset of hydrogen sulfide detection at the second end of the section, minus the detention time. For example, if the onset of hydrogen sulfide detection at the second end of the section of sewer pipeline routinely occurs at 6 AM, and the predicted detention time in the section is ten hours, then the feed of wastewater treatment chemical at the first end can be initiated at 8 PM on the preceding evening.

In one embodiment of the method, another step is to discontinue the feed of wastewater treatment at the first end of the section of sewer pipeline at a time equal to when hydrogen sulfide is no longer detected at the second end of the section, minus the detention time. For example, if the offset of hydrogen sulfide detection at the second end of the section of sewer pipeline routinely occurs at 2 PM, and the predicted detention time is ten hours, then the feed of wastewater treatment chemical at the first end can be discontinued at 4 AM on the same day.

In one embodiment of the invention, another step is to obtain a dissolved oxygen profile as an alternative to the hydrogen sulfide profile for the section of sewer pipeline that is being treated. When there is no dissolved oxygen in the wastewater, hydrogen sulfide will begin to form. When there is dissolved oxygen in the wastewater, hydrogen sulfide will stop forming. The dissolved oxygen profile uses empirical data to record and approximate the presence and absence of dissolved oxygen over time at a selected point along the section of sewer pipeline, for example, by continuously monitoring dissolved oxygen at the second end of the section of sewer pipeline. The dissolved oxygen profile can be used to predict the instant wastewater flow rate and time at which hydrogen sulfide is generated (during periods of decreasing wastewater flow) and the instant wastewater flow rate and time at which hydrogen sulfide is no longer generated (during periods of increasing wastewater flow). The dissolved oxygen profile can be used interactively with the flow rate profile to predict when hydrogen sulfide will be generated, and when it will stop being generated, at various times of the day, on different days of the week, and in different months of the year. When the dissolved oxygen profile is used instead of the hydrogen sulfide profile, the remaining steps can be performed as explained above.

In a typical sewer operation, the first end and second end are both sections of the sewer line called “pump stations” or “lift stations.” These lift stations exist at low points in sewer lines where the sewage will not flow to the wastewater treatment plant (WWTP) by gravity forces because of a hill or other incline in the way. The lift station has a sump that gradually fills with incoming sewage (wastewater) until it rises to a set level (float or other type of level sensor) that triggers the lift station pump to come on and pump the sewage out of the sump and onward toward the WWTP. The sewage is pumped into a pipe that is slanted uphill. Therefore, it is always full of sewage at all times of the day and night, until at some point downstream of the lift station the terrain angles downward, allowing the sewage from that point forward to flow by gravity to the next low point in the sewer system. This next low point will be the next lift station (second end). Alternatively, the next low point could be the headworks sump that marks the beginning of the WWTP. In this case, the headworks would be the second end.

The pipe that is slanted uphill is called a “force main.” When the sewage flow rate is low in the middle of the night, the sewage in the force main is held there for a long detention time. During this long detention time, the bacteria in the force main pipe consume the dissolved oxygen and then begin to convert sulfate into H₂S. When the flow rate picks up in the morning, the H₂S-laden sewage in the force main begins to travel to the second end lift station. When it spills into the sump at the second end lift station, the H₂S odor (and its corrosive effects) are strongly observed.

With the foregoing in mind, it is a feature and advantage of the invention to provide a method of regulating the feed of wastewater treatment chemical in a section of sewer pipeline having a first and a second end. In one embodiment, the method includes the following steps:
obtaining a wastewater flow rate profile for the section of sewer pipeline;
initiating a feed of wastewater treatment chemical at the first end of the section of sewer pipeline when the wastewater flow rate falls below a first threshold; and
discontinuing the feed of wastewater treatment chemical at the first end of the section of sewer pipeline when the wastewater flow rate rises above a second threshold.

In another embodiment, the method includes the following steps:
obtaining a wastewater flow rate profile for the section of sewer pipeline;
obtaining a hydrogen sulfide profile for the section of sewer pipeline by monitoring hydrogen sulfide detection at the second end of the section of sewer pipeline;
using the wastewater flow rate profile and the hydrogen sulfide profile, obtaining a first instant flow rate below which hydrogen sulfide is detected at the second end, a second instant flow rate above which hydrogen sulfide is no longer detected at the second end, and a low flow rate period having a start time corresponding to the first instant flow rate and an end time corresponding to the second instant flow rate;
determining a wastewater detention time in the section of sewer pipeline during the low flow rate period;
initiating a feed of wastewater treatment chemical at the first end of the section of sewer pipeline at a time equal to the start time minus the detention time; and
discontinuing the feed of wastewater treatment chemical at the first end of the section of sewer pipeline at a time equal to the end time minus the detention time.

In another embodiment, the method includes the following steps:
obtaining a wastewater flow rate profile for the section of sewer pipeline;
obtaining a dissolved oxygen profile for the section of sewer pipeline by monitoring dissolved oxygen detection at the second end of the section of sewer pipeline;
using the wastewater flow rate profile and the dissolved oxygen profile, obtaining a first instant flow rate below which dissolved oxygen is not detected at the second end, a second instant flow rate above which dissolved oxygen is detected at the second end, and a low flow rate period having a start time corresponding to the first instant flow rate and an end time corresponding to the second instant flow rate;
determining a wastewater detention time in the section of sewer pipeline during the low flow rate period;
initiating a feed of wastewater treatment chemical at the first end of the section of sewer pipeline at a time equal to the start time minus the detention time; and
discontinuing the feed of wastewater treatment chemical at the first end of the section of sewer pipeline at a time equal to the end time minus the detention time.

These and other features and advantages of the invention will become further apparent from the following Detailed Description. The Detailed Description is intended to be exemplary and nonlimiting, with the scope of the invention being defined by the appended claims.

### DETAILED DESCRIPTION OF THE INVENTION

In accordance with the invention, a method of regulating the feed of wastewater treatment chemical in a section of sewer pipeline is provided, where the section of sewer pipeline has a first end and a second end. The wastewater treatment chemical can be any new or conventional chemical and can include, for example, magnesium hydroxide, magnesium oxide, calcium hydroxide, calcium oxide, sodium hydroxide, sodium carbonate, sodium bicarbonate, potassium carbonate, potassium bicarbonate, hydrogen peroxide, ferric chloride, ferrous chloride, ferrous sulfate, other ferrous and ferric salts, salts of nitrate (sodium, calcium, etc.), chlorine, sodium hypochlorite, other oxidizers, and combinations thereof. During periods of use, these chemicals are injected into the sewage stream by direct injection at the first end of the section of sewer pipeline. These chemicals can, for example, be injected in amounts ranging from about 50 ppm to about 500 ppm based on the wastewater flow during periods of use, as explained below.

In one embodiment, the invention includes the step of obtaining a wastewater flow rate profile for the section of sewer pipeline. This can be generated using empirical data by monitoring and recording the wastewater flow rate over a selected period of time. The selected period of time can be weekly, monthly, annually, or any time period that may provide beneficial information. For example, daily profiles can inform as to how much wastewater is being discharged into the section of sewer pipeline at various times of the day. A weekly profile can inform as to which days of each week generate higher and lower wastewater flow rates, and a monthly profile can inform as to which months of the year generate higher and lower amounts of wastewater. An annual profile can incorporate all of the above (daily, weekly, monthly etc.) into one master profile.

In one embodiment, the invention includes the step of obtaining a hydrogen sulfide profile for the section of sewer pipeline. This can be done by monitoring the hydrogen sulfide detection at the second end of the section of sewer pipeline. The hydrogen sulfide profile can be generated using empirical data by monitoring and recording when and/or how much hydrogen sulfide is detected over a selected period of time. Again, the selected period of time can be weekly, monthly, annually, or any time period that may provide beneficial information. For example, daily profiles can inform as to when or how much hydrogen sulfide detected at the second end of the section of sewer pipeline at various times of the day. A weekly profile can inform as to which days of each week generate longer and shorter periods of hydrogen sulfide detection, and the times of detection. A monthly profile can inform as to which months of the year generate longer and shorter periods of hydrogen sulfide detection, and the times of detection. An annual profile can incorporate all of the above (daily, weekly, monthly etc.) into one master profile.

As explained above, a dissolved oxygen profile can be generated instead of a hydrogen sulfide profile to predict when hydrogen sulfide will be generated and when it will not. When dissolved oxygen is detected, hydrogen sulfide will no longer form. When dissolved oxygen is no longer detected, hydrogen sulfide will form. This can be done by monitoring the dissolved oxygen detection at the second end of the section of sewer pipeline. The dissolved oxygen profile can be generated using empirical data by monitoring and recording when and/or how much dissolved oxygen is detected over a selected period of time. Again, the selected period of time can be weekly, monthly, annually, or any time period that may provide beneficial information. For example, daily profiles can inform as to when or how much dissolved oxygen is detected at the second end of the section of sewer pipeline at various times of the day. A weekly profile can inform as to which days of each week generate longer and shorter periods of dissolved oxygen detection, and the times of detection. A monthly profile can inform as to which months of the year generate longer and shorter periods of dissolved oxygen detection, and the times of detection. An annual profile can incorporate all of the above (daily, weekly, monthly etc.) into one master profile.

The wastewater flow rate profile and the hydrogen sulfide or dissolved oxygen profile can be used to determine a first instant flow rate below which hydrogen sulfide is detected, or below which dissolved oxygen is not detected, at the second end; a second instant flow rate above which hydrogen sulfide is no longer detected, or which dissolved oxygen is detected, at the second end; and a low flow rate period having a start time corresponding to the first instant flow rate and an end time corresponding to the second instant flow rate. During the low flow rate period, the flow of wastewater through the section of sewer pipeline will generally be low enough to result in the detection of hydrogen sulfide and/or the absence of dissolved oxygen at the second end. Due to hysteresis, the first instant flow rate may not be equal to the second instant flow rate. The first instant flow rate will generally occur during a period of declining wastewater flow and the second instant flow rate will generally occur during a period of increasing wastewater flow, resulting in the second instant flow rate being somewhat higher than the first instant flow rate.

Because the wastewater treatment chemical is typically injected at the first end of the section of sewer pipeline and the hydrogen sulfide or dissolved oxygen detection is monitored at the second end, it is desirable to account for the detention time of wastewater in the section of sewer pipeline between the first end and the second end. Because at least a portion of the section of sewer pipeline runs at a slightly upward angle, as explained above, the section of sewer pipeline will typically be filled with wastewater. The detention time can therefore be determined by first determining the volume of the section of sewer pipeline. Assuming constant diameter, the volume can be calculated by multiplying the cross-sectional area of the section of sewer pipeline by its length. The detention time can then be estimated by dividing the volume by a representative flow rate that exists during the period of low wastewater flow, and during which the hydrogen sulfide is detected, or the dissolved oxygen is not detected at the second end. The representative flow rate will typically be lower than the first instant flow rate but can, in some circumstances, be in between the first instant flow rate and the second instant flow rate. The representative flow rate can be determined or estimated using the wastewater flow rate profile.

In one embodiment of the invention, the feed of wastewater treatment chemical can be initiated at the first end of the section of sewer pipeline at a time which is equal or proximate to the start time corresponding to the first instant flow rate minus the detention time. The feed of wastewater treatment chemical can then be continued for a time period that is equal or proximate to the detention time during the low flow rate period. The feed of wastewater treatment chemical at the first end of the section of sewer pipeline can then be discontinued at a time that is equal or proximate to the end time corresponding to the second instant flow rate, minus the detention time during the low flow rate period.

The foregoing method ensures that the wastewater treatment chemical will only be injected into the section of sewer pipeline during time periods in which detectable amounts of hydrogen sulfide are being generated, specifically during time periods when the wastewater flow rate through the section of sewer pipeline is low enough to facilitate hydrogen sulfide generation and release. This saves the environment from unnecessary levels of chemical and results in a much cleaner sewer system in which the generation of noxious odors is minimized.

Embodiments of the invention may vary depending on the types and amounts of wastewater treatment chemicals being used. Depending on the type of wastewater treatment chemical, it may be desirable to vary the amounts being injected at the first end during periods of low wastewater flow. In one embodiment, the wastewater temperature can be monitored at the first end, and the dosage of wastewater treatment chemical can be varied depending on the wastewater temperature. This is because the rate of chemical reaction generally increases, and the performance of the chemical becomes more efficient, at higher temperatures. However, the chemical processes that generate the hydrogen sulfide also become faster and more efficient at higher temperatures.

In another embodiment, the pH or alkalinity of the wastewater can be monitored at the first end and the dosage of the chemical treatment can be varied accordingly. Depending on the wastewater treatment chemical, its performance may vary depending on whether the pH is acidic or alkaline and, if alkaline, the degree of alkalinity.

In another embodiment, the type and/or concentration of bacteria in the wastewater can be monitored at the first end and/or the second end of the section of sewer pipeline. The type and/or dosage wastewater treatment chemical can then be varied in accordance with the type and/or concentration of the bacteria.

In another embodiment, the concentration of ammonia and/or amines in the wastewater can be monitored at the first end, as these compounds influence both pH and bacterial growth. The type and/or dosage of wastewater treatment chemical can be varied according to the level of ammonia and/or amines.

In another embodiment, the concentration of carbonaceous material can be monitored at the first end of the section of sewer pipeline. Total organic carbon content can be indicative of biological oxygen demand, which in turn influences bacterial growth and hydrogen sulfide generation. The type and/or dosage of wastewater treatment chemical can be varied according to the level of carbonaceous material in the wastewater.

Other embodiments of the invention will become further apparent to persons of ordinary skill in the art. The scope of the invention is indicated in the appended claims, and all changes that fall within the meaning and range of equivalents are intended to be embraced therein.

We claim:

1. A method of regulating the feed of wastewater treatment chemical in a section of sewer pipeline having a first and a second end, comprising the steps of:
obtaining a wastewater flow rate profile for the section of sewer pipeline;
initiating a feed of wastewater treatment chemical at the first end of the section of sewer pipeline when the wastewater flow rate falls below a first threshold; and
discontinuing the feed of wastewater treatment chemical at the first end of the section of sewer pipeline when the wastewater flow rate rises above a second threshold.

2. A method of regulating the feed of wastewater treatment chemical in a section of sewer pipeline having a first and a second end, comprising the steps of:
obtaining a wastewater flow rate profile for the section of sewer pipeline;
obtaining a hydrogen sulfide profile for the section of sewer pipeline by monitoring hydrogen sulfide detection at the second end of the section of sewer pipeline;
using the wastewater flow rate profile and the hydrogen sulfide profile, obtaining a first instant flow rate below which hydrogen sulfide is detected at the second end, a second instant flow rate above which hydrogen sulfide is no longer detected at the second end, and a low flow rate period having a start time corresponding to the first instant flow rate and an end time corresponding to the second instant flow rate;
determining a wastewater detention time in the section of sewer pipeline during the low flow rate period;
initiating a feed of wastewater treatment chemical at the first end of the section of sewer pipeline at a time equal to the start time minus the detention time; and
discontinuing the feed of wastewater treatment chemical at the first end of the section of sewer pipeline at a time equal to the end time minus the detention time.

3. A method of regulating the feed of wastewater treatment chemical in a section of sewer pipeline having a first and a second end, comprising the steps of:
obtaining a wastewater flow rate profile for the section of sewer pipeline;
obtaining a dissolved oxygen profile for the section of sewer pipeline by monitoring dissolved oxygen detection at the second end of the section of sewer pipeline;
using the wastewater flow rate profile and the dissolved oxygen profile, obtaining a first instant flow rate below which dissolved oxygen is not detected at the second end, a second instant flow rate above which dissolved oxygen is detected at the second end, and a low flow rate period having a start time corresponding to the first instant flow rate and an end time corresponding to the second instant flow rate;
determining a wastewater detention time in the section of sewer pipeline during the low flow rate period;
initiating a feed of wastewater treatment chemical at the first end of the section of sewer pipeline at a time equal to the start time minus the detention time; and
discontinuing the feed of wastewater treatment chemical at the first end of the section of sewer pipeline at a time equal to the end time minus the detention time.

4. The method of claim 1, wherein the wastewater flow rate profile is generated using empirical data by monitoring and recording the wastewater flow rate over a selected period of time.

5. The method of claim 2, wherein the wastewater flow rate profile is generated using empirical data by monitoring and recording the wastewater flow rate over a selected period of time.

6. The method of claim 3, wherein the wastewater flow rate profile is generated using empirical data by monitoring and recording the wastewater flow rate over a selected period of time.

7. The method of claim 2, wherein the hydrogen sulfide profile is generated using empirical data by monitoring and recording the detection of hydrogen sulfide at the second end of the section of sewer pipeline over time.

8. The method of claim 3, wherein the dissolved oxygen profile is generated using empirical data by monitoring and recording the detection of hydrogen sulfide at the second end of the section of sewer pipeline over time.

9. The method of claim 2, wherein the detention time is determined by determining a volume of the section of sewer pipeline and dividing the volume by a representative flow rate that exists during the low flow rate period.

10. The method of claim 3, wherein the detention time is determined by determining a volume of the section of sewer pipeline and dividing the volume by a representative flow rate that exists during the low flow rate period.

11. The method of claim 1, further comprising the step of varying a dosage of the wastewater treatment chemical at the first end of the section of sewer pipeline.

12. The method of claim 6, further comprising the step of monitoring a wastewater temperature at the first end of the section of sewer pipeline and varying the dosage of the wastewater treatment chemical based on the wastewater temperature.

13. The method of claim 6, further comprising the step of monitoring a wastewater pH or alkalinity at the first end of the section of sewer pipeline and varying the dosage of the wastewater treatment chemical based on the pH or alkalinity.

14. The method of claim 6, further comprising the step of monitoring a type and concentration of bacteria at the first end and/or the second end of the section of sewer pipeline and varying the dosage of the wastewater treatment chemical based on the type and concentration of the bacteria.

15. The method of claim 6, further comprising the step of monitoring a concentration of ammonia and/or amines at the first end of the section of sewer pipeline and varying the dosage of the wastewater treatment chemical based on the concentration of ammonia and/or amines.

16. The method of claim 6, further comprising the step of monitoring a concentration of carbonaceous material at the first end of the section of sewer pipeline and varying the dosage of the wastewater treatment chemical based on the concentration of carbonaceous material.

17. The method of claim 2, further comprising the step of varying a dosage of the wastewater treatment chemical at the first end of the section of sewer pipeline.

18. The method of claim 12, further comprising the step of monitoring a wastewater temperature at the first end of the section of sewer pipeline and varying the dosage of the wastewater treatment chemical based on the wastewater temperature.

19. The method of claim 12, further comprising the step of monitoring a wastewater pH or alkalinity at the first end of the section of sewer pipeline and varying the dosage of the wastewater treatment chemical based on the pH or alkalinity.

20. The method of claim 12, further comprising the step of monitoring a type and concentration of bacteria at the first end and/or the second end of the section of sewer pipeline and varying the dosage of the wastewater treatment chemical based on the type and concentration of the bacteria.

21. The method of claim 12, further comprising the step of monitoring a concentration of ammonia and/or amines at the first end of the section of sewer pipeline and varying the dosage of the wastewater treatment chemical based on the concentration of ammonia and/or amines.

22. The method of claim 12, further comprising the step of monitoring a concentration of carbonaceous material at the first end of the section of sewer pipeline and varying the dosage of the wastewater treatment chemical based on the concentration of carbonaceous material.

23. The method of claim 3, further comprising the step of varying a dosage of the wastewater treatment chemical at the first end of the section of sewer pipeline.

24. The method of claim 18, further comprising the step of monitoring a wastewater temperature at the first end of the section of sewer pipeline and varying the dosage of the wastewater treatment chemical based on the wastewater temperature.

25. The method of claim 18, further comprising the step of monitoring a wastewater pH or alkalinity at the first end of the section of sewer pipeline and varying the dosage of the wastewater treatment chemical based on the pH or alkalinity.

26. The method of claim 18, further comprising the step of monitoring a type and concentration of bacteria at the first end and/or the second end of the section of sewer pipeline and varying the dosage of the wastewater treatment chemical based on the type and concentration of the bacteria.

27. The method of claim 18, further comprising the step of monitoring a concentration of ammonia and/or amines at the first end of the section of sewer pipeline and varying the dosage of the wastewater treatment chemical based on the concentration of ammonia and/or amines.

28. The method of claim 18, further comprising the step of monitoring a concentration of carbonaceous material at the first end of the section of sewer pipeline and varying the dosage of the wastewater treatment chemical based on the concentration of carbonaceous material.
